(19) United States
(12) Patent Application Publication
(10) Pub. No.: US 2012/0256145 A1
(43) Pub. Date: Oct. 11, 2012

(54) LIFTING APPARATUS, ESPECIALLY CABLE TRACTION MECHANISM, COMPRISING CONNECTING POSSIBILITIES

(75) Inventors: Dingyuan Zhao, Shanghai (CN); Wenke Sui, Shanghai (CN); Jinping Zhang, Shanghai (CN); Gereon Imbusch, Mettmann (DE); Thomas Kohlenberg, Paderborn (DE); Franz Schulte, Herdecke (DE)

(73) Assignee: Demag Cranes & Components GmbH, Wetter (DE)

(21) Appl. No.: 13/510,607

(22) PCT Filed: Nov. 15, 2010
(86) PCT No.: PCT/EP2010/067493

§ 371 Date: Jun. 28, 2012

(30) Foreign Application Priority Data
Nov. 21, 2009 (DE) 10 2009 054 225.6
Nov. 21, 2009 (DE) 10 2009 054 226.4
Oct. 19, 2010 (DE) 10 2010 048 946.8

(51) Int. Cl. B66D 1/00

(52) U.S. Cl. 254/266

(57) ABSTRACT

A lifting apparatus, especially a cable traction mechanism, comprising a base frame that has at least two base plates, further comprising at least two longitudinal beams that interconnect the base plates and are spaced apart from each other, and at least one attachable cross-member for cable reeving parts that is fastened to the base plates and extends substantially parallel to the longitudinal beams. Multiple mounting points, to which the attachable cross-member for cable reeving parts can be alternatively and detachably fastened, may be arranged on each of the base plates to promote modularity of the lifting apparatus.

### RELATED APPLICATION

The present application claims the priority benefits of International Patent Application No. PCT/EP2010/067493, filed on Nov. 15, 2010, and also of German Patent Application Nos. DE 10 2009 054 226.4, filed on Nov. 21, 2009, DE10 2009 054.225.6, filed on Nov. 21, 2009, and DE 10 2010 048 946.8, filed on Oct. 19, 2010, which are all hereby incorporated herein by reference in their entireties.

### BACKGROUND OF THE INVENTION

The invention relates to a cable winch having a base frame.

From the German patent DE 10 2005 029 113 B3 a cable winch is known which is driven by an electric motor. The electric motor is flange-mounted on a transmission which is attached laterally and externally to a base frame. The base frame has two base plates disposed in parallel and at a spaced disposition with respect to each other. The base plates are spaced apart from each other via tubular longitudinal beams and are releasably connected to each other. A cable drum is mounted between the base plates and is driven by the electric motor, the rotational axis of which cable drum is orientated in parallel with the longitudinal extension of the longitudinal beams. The components of the lifting apparatus previously designated as base plates can also be housing parts which fulfil different functions of the lifting apparatus. For example, these serve for reception of transmission components, for attachment of the lifting drive, for mounting of the cable drum, for mounting of cross-beams for parts of the cable reeving arrangement, for receiving the electrical equipment, for attachment, including foot-attachment, of the lifting apparatus or for attachment of travelling mechanism parts.

From US 2008/0061277 A1 a marine winch is known. The marine winch has a cable drum which is rotatably mounted between two base plates of a base frame. The base plates are spaced apart from each other and connected to each other via longitudinal beams extending in parallel with the longitudinal direction of the cable drum. Cable guide rollers are provided in order to allow a cable wound on the cable drum to run off from the cable drum or its cable grooves in an ordered manner. The cable guide rollers are, for this purpose, disposed between the base plates and in the region of the circumference of the cable drum. For rotatable mounting of the cable guide rollers, these are each pushed onto a tie rod which serves as a rotational axis, extends in parallel with the longitudinal direction of the cable drum and is attached with both its ends to the inner sides of the base plates.

In US 2009/0308826 A1 a winch for stage use with a cable drum and a comparable base frame consisting of two base plates and longitudinal beams is described. In order to permit uniform winding or unwinding of a cable from the cable drum, a frame-like cable guide device is additionally provided, which is attached to the base plates of the stage winch. The cable running in or out with respect to the cable drum is guided or pretensioned via cable guide rollers which are rotatably mounted on longitudinal beams of the cable guide device disposed between the side walls.

### SUMMARY OF THE INVENTION

The object of the invention is to create a lifting apparatus, in particular a cable winch, which is characterised by a modular design.

This object is achieved by a lifting apparatus, in particular a cable winch, in accordance with the present invention.

In accordance with an embodiment of the invention, in the case of a cable winch having a base frame comprising at least two base plates, having at least two longitudinal beams connecting the base plates together and being at a spaced disposition with respect to each other, and having at least one mounting cross-beam for cable reeving parts, which is attached to the base plates and extends substantially in parallel with the longitudinal beams, wherein the cable reeving parts are formed as cable pulleys or cable fixed points which are attached to the mounting cross-beams, a modular design is achieved by virtue of the fact that a plurality of attachment locations are disposed on each of the base plates, on which attachment locations the mounting cross-beam for cable reeving parts can be releasably attached as desired. Therefore, it is easily possible to create a kind of outline on which then, as required, one or two mounting cross-beams for cable reeving parts can be mounted at the respectively required attachment locations. By means of the attachment locations, a universal interface between the base plates and the mounting cross-beams for cable reeving parts is created. In the previously known solutions there is no coherent design for the attachment of the different reeving assemblies such as upper pulleys and cable fixed point cross-beams for the various reeving relationships (such as 2/1; 4/1; 4/2 etc) and the different designs of the lifting apparatus such as lower flange trolley, monorail trolley in a short design type, two-rail trolley and stationary lifting mechanism such as a foot-mounted hoist. Many different assemblies and components are required. This is avoided by the present invention so that the known disadvantages such as high number of parts, cumbersome logistics and administration, high parts costs owing to small batch numbers, inefficient manufacturing and expensive storage have their full impact.

Provision is advantageously made that the base plates are formed in a substantially square or rectangular manner and the attachment locations are disposed on at least two different edges of the base plates. Three attachment locations may be provided per base plate.

In order that the mounting cross-beam for cable reeving parts can also be mounted between the base plates when the cable drum is already mounted or can be shifted to another attachment location, the attachment locations may be disposed outside the regions of the base plates concealed by the cable drum when seen in the direction of the rotational axis of the cable drum. The attachment locations may also be disposed on the inner sides of the base plates.

Space is particularly saved if the attachment locations are formed as first apertures on the first base plate and second apertures on the second base plate. Therefore, the reception plates can be attached to the base plates without the useable length of the cable drum being diminished.

In order easily to permit attachment of the mounting cross-beam for cable reeving parts in a laterally projecting manner with respect to the base plates, the mounting cross-beam for cable reeving parts can be releasably attached to the base plates via first and second reception plates. The first and second reception plates can be placed into the first and second apertures and have an attachment part projecting beyond the contour of the first and second base plates. In this way the suspension bores for the mounting cross-beams of the cable reeving arrangement can easily be produced as bores in simple metal sheets such as the reception plates. These reception plates can easily be mounted in a modular manner as required into the cast parts of the base plates such that the same contact distance of the reception plates is always achieved for a lifting mechanism length. However, when the reception plates are dismounted, the respective sides of the base plates continue to be available for mounting the lifting mechanism to a given connection structure. Furthermore, the overall dimensions of the lifting mechanism with the reception plates dismounted remain advantageously small. The actual functions and dimensions of the lifting gear and of the foot flange are not diminished by the possible mounting of the reception plates. This applies equally for all installation positions of the lifting mechanism and construction types within the series with a fixed length for the lifting mechanism. Considered over the different lengths of the lifting mechanism, the principle of storage and possible mounting of the reception plates remains the same, which means a true modular solution with a simple kit is produced.

In order to be able to follow the vertical orientation of the cable to be wound and unwound, the mounting cross-beam is suspended in an oscillating manner on the respective attachment part of the first and second reception plates.

In a conventional manner, a cable drum is mounted on both ends between and on the inner sides of the base plates, the axis of rotation of the cable drum being orientated in parallel with the longitudinal axis of the longitudinal beams.

An exemplified embodiment of the invention will be explained in more detail hereinafter with reference to the accompanying drawings.

### BRIEF DESCRIPTION OF THE DRAWINGS

FIG. 1 shows a perspective view of a cable winch in accordance with the invention, formed as a foot-mounted hoist,

FIG. 2 shows a side view of FIG. 1 partially in vertical section,

FIG. 3 shows a plan view of FIG. 1,

FIG. 4 shows a detailed view of FIG. 1 of an inner side of a first base plate,

FIG. 5 shows a detailed view of FIG. 1 of an inner side of a second base plate and

FIG. 6 shows a perspective view of a cable winch in accordance with the invention as a monorail crane trolley in a lower flange design.

### DESCRIPTION OF THE PREFERRED EMBODIMENTS

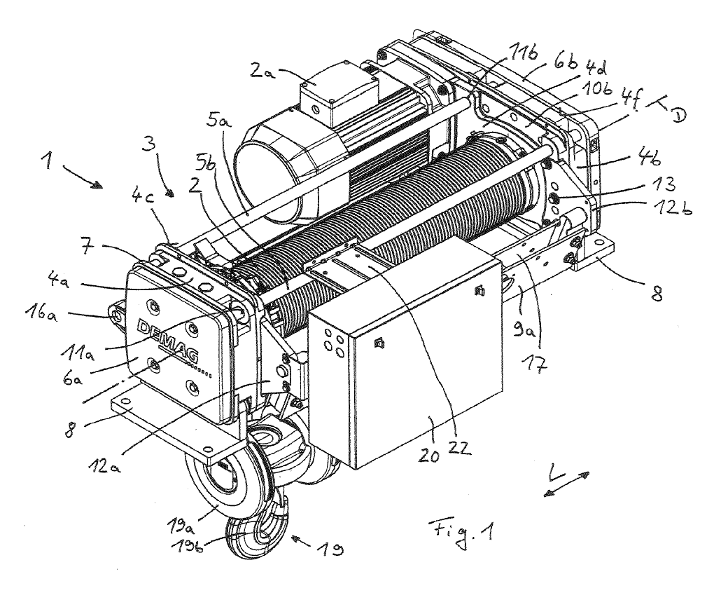

FIG. 1 shows a perspective view of a cable winch 1 in accordance with the invention having a cable drum 2 which is mounted at both ends in a base frame 3. The cable winch 1 is formed as a so-called foot-mounted hoist and, with angle elements 8 attached to the base frame 3, is set on a support structure, not shown, or on a warehouse floor and attached at that location.

The base frame 3, which is on the whole shaped like a cuboid, consists on the one hand of a first base plate 4a and a second base plate 4b, the cable drum 2 being mounted on the mutually facing first and second inner sides 4c and 4d thereof. The cable drum 2 is rotatable about a rotational axis D and is driven by an electric motor 2a via a transmission 2b. The first base plate 4a and the second base plate 4b are each cuboidal or rectangular as seen in cross-section and each formed with rounded corner regions.

On the other hand, the cuboidal base frame 3 consists of several longitudinal beams, up to a maximum of four, of which a first longitudinal beam 5a and a second longitudinal beam 5b can be seen in FIG. 1. A third longitudinal beam is disposed below the first longitudinal beam 5a and is concealed by the cable drum 2. The base plates 4a, 4b are spaced apart from each other and connected together via the longitudinal beams 5a, 5b. The longitudinal beams 5a, 5b are disposed in the corners of an imaginary quadrilateral in the first and second base plates 4a, 4b. In the case of the first base plate 4a, the longitudinal beams 5a, 5b are disposed in the corner regions of the virtually square base plate 4b. The second base plate 4b comprises, compared with the first base plate 4a, a rectangular shape since this is extended beyond the second longitudinal beam 5b for attaching the electric motor 2a. In a corresponding manner, the second longitudinal beam 5b and a possible fourth longitudinal beam are disposed in the region of the front corner regions of the second base plate 4b and the first longitudinal beam 5a and the third longitudinal beam are disposed approximately in the region of the centre and of the side edge of the second base plate 4b. Furthermore, this second base plate 4b receives the transmission 2b in the region of its outer side 4f, which transmission connects the cable drum 2 to the electric motor 2a in a drivable manner. For this purpose the base plate 4b is formed in the manner of a pot or trough in the region of its outer side 4f.

The longitudinal beams 5a, 5b are formed as solid bars and two to four longitudinal beams 5a, 5b are provided depending upon the usage application of the cable winch 1, said beams being disposed in selected corners, or in all corners, of the base plates 4a, 4b. The longitudinal beams 5a, 5b are used to connect the base plates 4a, 4b together so as to be resistant to twisting and the desired distance and the parallelism between the two base plates 4a, 4b within the desired tolerances are achieved by the length of the longitudinal beams 5a, 5b. In the illustrated exemplified embodiment, a total of three longitudinal beams 5a, 5b are provided. A fourth longitudinal beam 5 is not mounted in order not to hinder the winding and unwinding of a cable, not shown, from the cable drum 2. The longitudinal beams 5a, 5b each comprise a first beam end and an opposite second beam end. The first beam ends are each releasably attached in the first base plate 4a and the second beam ends are each releasably attached in the second base plate 4b. Screw connections are preferably used for this purpose and first and second reception openings 11a, 11b for receiving the beam ends of the longitudinal beams 5a, 5b are disposed in the base plates 4a, 4b.

FIG. 1 shows the cable winch in a so-called operating state, i.e., after assembly of the longitudinal beams 5a, 5b. In this operating state the longitudinal beams 5a, 5b are orientated with their longitudinal axes L in parallel with and laterally offset from the rotational axis D of the cable drum 2.

FIG. 1 shows a cable winch 1 as a so-called foot-mounted hoist. This cable winch 1 can, when using other mounting elements, also become—instead of the illustrated angle elements 8—a component of a crane trolley, in which travelling mechanism components are attached to the base plates 4a, 4b. Possible crane trolley designs include a lower flange crane trolley, a monorail crane trolley in a short design with the cable winch 1 arranged next to the rail, and a two-rail crane trolley. The number of longitudinal beams 5a and 5b can vary between two to four and is dependent on the respective stability requirements of the base frame 3 and the installation position of the cable winch 1 and the resulting cable run-out from the cable drum 2. It can be advantageous to dispense with a support rod in the region of the cable run-out.

In a corresponding manner, the base plates 4a 4b have, in addition to mounting the cable drum 2, various other functions such as for example receiving transmission components, supporting the electric drive 2a, receiving mounting cross-beams for parts of a cable reeving arrangement, housing electric equipment, allowing the attachment of feet of the cable winch or attaching travelling mechanism parts.

In order to attach first and second mounting cross-beams 9a, 9b for parts of a cable reeving arrangement between the two base plates 4a, 4b, extending in parallel with the cable drum 2 and adjacent the cable drum 2, respective attachment locations are provided on the inner side 4c of the first base plate 4a and on the inner side 4d of the second base plate 4b. In each case a plurality of attachment locations are provided, of which one or two are used to selectively attach first and second mounting cross-beams 9a, 9b to the cable winch 1 as required and according to the use of the cable winch, the orientation of the electric motor 2a and the desired position of the run-out of the cable from the cable drum. The attachment locations are formed as first apertures 10a let into the inner side 4c of the first base plate 4a, and second apertures 10b let into the inner side 4d of the second base plate 4b. For each base plate 4a, 4b three apertures 10a, 10b are provided which each have an essentially flat and rectangular shape and extend with their longitudinal extension in parallel with the outer edge of the respective base plate 4a, 4b. The first and second apertures 10a, 10b are also each disposed outside the corner regions with the first and second reception openings 11a, 11b for the longitudinal beams 5a and 5b and therefore between the reception openings 11a, 11b. A respective first and a second reception plate 12a, 12b in the desired number are placed into the first and second apertures 10a, 10b and at the desired attachment locations are placed into a respective first and second aperture 10a, 10b and then attached to the first and second base plates 4a, 4b with at least two screws 13 at that location. The reception plates 12a, 12b can be separated in relation to their function into an attachment region 12c and a suspension region 12d. In the attachment region 12c the releasable attachment of the reception plates 12a, 12b in the apertures 10a, 10b takes place and in the suspension region 12d the attachment of the mounting cross-beam 9 takes place. Furthermore, the reception plates 12a, 12b are flat and in the form of sheet metal and have a thickness corresponding to the depth of the aperture 10a, 10b as seen in the longitudinal direction L and looking towards the respective inner side 4c, 4d of the base plate 4a, 4b. The outer contour of the reception plates 12a, 12b is selected such that these plates fit with their attachment region 12c into the apertures 10a, 10b while maintaining a gap. The apertures 10a, 10b are open to the outer edge of the base plate 4a, 4b so that the reception plate 12a, 12b projects laterally over the base plate 4a, 4b with its suspension region 12d. The reception plates 12a, 12b as a whole have an almost triangular shape with a flattened peak and a rectangular base in the attachment region 12c. In the attachment region 12c, three bores 14 are provided through which the screws 13 are passed and are screwed in threaded bores 14 in the inner side 4c, 4d of the base plate 4a, 4b in the region of the apertures 10a, 10b. In order to transfer the forces between the reception plates 12a, 12b and the base plates 4a, 4b, alignment pins or bushings are provided in addition to the screws 13 or the screws 13 are formed as fitting screws.

FIG. 1 shows that a first reception plate 12a is attached to the first base plate 4a in the region of its front edge, so that the suspension region 12d thereof projects forwards. In a corresponding manner a second reception plate 12b is disposed on the opposite second base plate 4b. In the respective suspension regions 12d, in the region of the end opposite the attachment region 12c, a first or second suspension bore 16a, 16b is disposed in each case. These suspension bores 16a, 16b serve for oscillating suspension of the front first mounting cross-beam 9a via bolts 9c disposed on the opposite ends thereof and projecting laterally. The first and second mounting cross-beams 9a, 9b are therefore pivotable about a horizontal axis which extends in parallel with the rotational axis D and horizontally. For this purpose the bolts 9c are disposed in the upper region of the mounting cross-beams 9a, 9b.

The mounting cross-beams 9a, 9b in their own right consist essentially of a thin rectangular frame of sheet metal, which defines an opening 17 orientated in the vertical direction. Elements of a cable drive which serve for attachment and guidance of a reeved cable can be installed in the opening 17 as required. The elements are conventionally formed as an upper pulley in the form of a single groove or multiple groove cable pulley 18a or as a cable fixed point 18b in the form of a cable wedge attached to the mounting cross-beam 9. The cable fixed point 18b serves to attach a cable end to the cable winch 1. The cable pulley 18a and the cable fixed point 18b are disposed between the walls of the mounting cross-beam 9a, 9b and are attached or mounted thereon. For this purpose, a plurality of bores are disposed in the mounting cross-beam 9a, 9b in order to dispose the cable pulley 18a and the cable fixed point 18b depending on the manner of the selected reeving at the correct position relative to the cable drum 2. A second mounting cross-beam 9b concealed by the cable drum 2 in FIG. 1 is provided, is disposed opposite the first mounting cross-beam 9a in relation to the cable drum 2 and supports a cable pulley 18a.

Furthermore, it is clear from FIG. 1 that the cable winch 1 has a load-receiving means in the form of a lower pulley 19 with two deflecting rollers 19c and a hook 19b. For the sake of clarity, the cables are not shown.

Furthermore, a housing for electrical equipment 20, in which electrical and electronic components are housed, is attached to the first reception plate 12a in the region of the first suspension bore 16a for the first mounting cross-beam 9a, the housing additionally being supported on the second support bar 5b.

The two base plates 4a, 4b in their own right are produced as cast parts and, so as to save weight, are in the shape of a pot open towards the outside having a first and second hollow space respectively, in which the drive, transmission, electrical or electronic components of the cable winch 1 can be housed. As previously stated, the transmission 2b is located in the second hollow space. Depending upon requirements and design, the first and second hollow spaces can be closed with a cover 6a, 6b or can remain open. The second hollow space in the second base plate 4b is closed by a second cover 6b which is attached to a second outer side 4e of the second base plate 4b via a frame-shaped holding element 7. This holding element 7 can also be the edge of the second cover 6b. The first hollow space in the first base plate 4a is closed by a first cover 6a which is directly attached to a first outer side 4e of the first base plate 4a via a frame-shaped holding element 7. This holding element 7 can also be the edge of the first cover 6a.

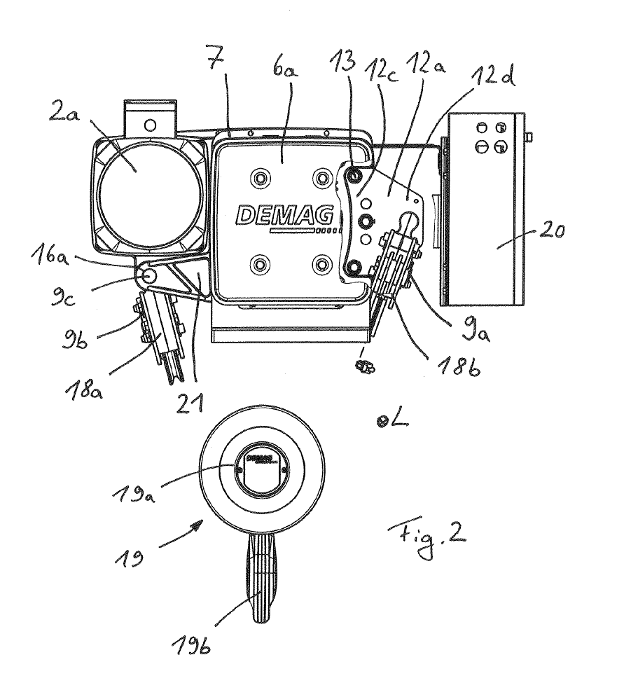

FIG. 2 shows a partially cut-away side view of the cable winch 1 of FIG. 1 from the region of the first reception plate 12a. The first reception plate 12a is screwed to the first base plate 4a in its attachment region 12c via at least two screws 13 and, in its suspension region 12d, supports a bolt 9c of the first mounting cross-beam 9a. The first mounting cross-beam 9a supports a cable fixed point 18b and the second mounting cross-beam 9b supports a cable pulley 18a. The second mounting cross-beam 9b is not attached to the first base plate via a reception plate 12a but via a reception arm 21 fixedly cast onto the first base plate 4a and projecting laterally. Like the reception plates 12a, 12b, the reception arm 21 has, on its free end, a first suspension bore 16a for receiving the bolt 9c of the second mounting cross-beam 9b. The first reception bore 16a in the suspension arm 21 is aligned with an opposing second suspension bore 16b—as seen in the longitudinal direction L—in the second base plate 4b which, however, is rectangular.

This also applies for the suspension bores 16a, 16b in the opposing reception plates 12a, 12b. Since this second base plate 4b is rectangular, the second suspension bore 16b can be produced directly in the second base plate 4b without providing a suspension arm 21.

FIG. 2 also shows that the second, left mounting cross-beam 9b is attached to the base plates 4a, 4b lower than the right, first mounting cross-beam 9a. This lower position is based on the fact that the electric motor 2b is disposed in the region of the inner side 4d of the second base plate 4b and therefore the second suspension bore 16b had to be displaced further towards the edge and further down in this installation position.

In relation to the first base plates 4a, it would be fundamentally possible to provide a modified suspension plate and therefore a fourth aperture instead of the suspension arm 21.

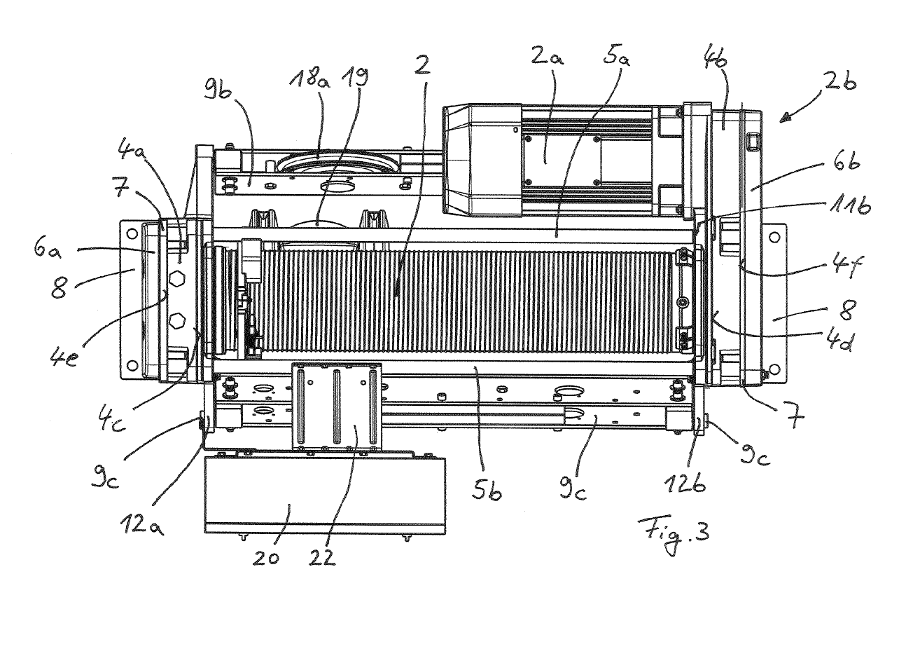

FIG. 3 shows a plan view of FIG. 1. In addition to the details already described in relation to FIGS. 1 and 2, it is particularly clear that the second mounting cross-beam 9b supports the cable pulley 18a serving as the upper pulley. The cable fixed point 18b is covered by a holder 22 for the electrical equipment housing 20. In relation to the second base plate 4b it is also clear to see that the second reception openings 11b for the longitudinal beams 5a, 5b, 5c are provided approximately in the middle of the second base plate 4b and the electric motor 2a is flange-mounted adjacently.

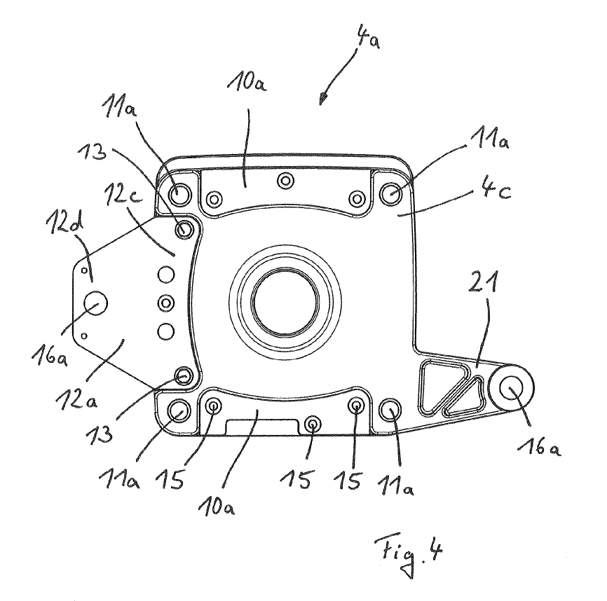

FIG. 4 shows a detailed view of the inner side 4c of the first base plate 4a. It can be seen that the first base plate 4a has an almost square cross-section and in the corners the four first reception openings 11a for the longitudinal beams 5a and 5b. Between the reception openings 11a in the region of three of the four edges the three first apertures 10a are disposed which essentially have a rectangular contour and are open towards the edge. In the region of the side facing the cable drum 2, the apertures 10a following the outer contour of the cable drum 2 are tapered in a concave or rounded manner so that the installation and removal thereof can also take place when the cable drum 2 is mounted. The laterally projecting reception arm 21 with the first suspension bore 16a can also be seen, this arm being disposed on the edge of the base plate 4a which does not have any of the first apertures 10a.

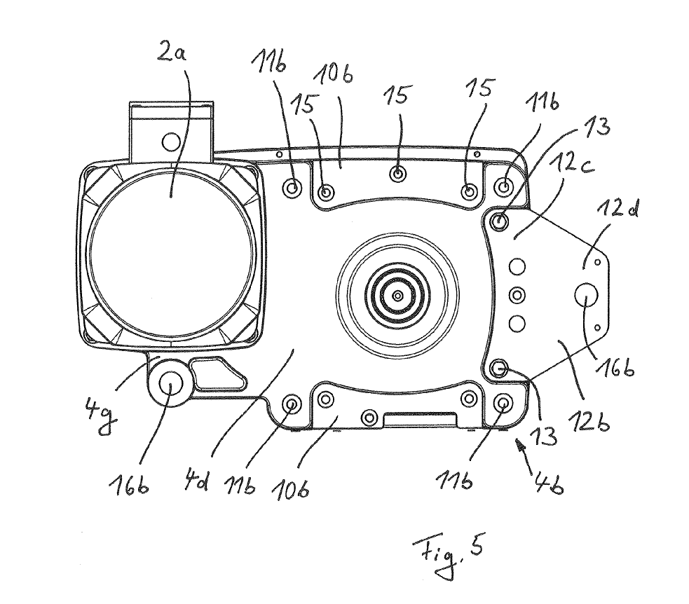

FIG. 5 shows a detailed view of the inner side 4d of the second base plate 4b. The second base plate 4b has an approximately rectangular cross-section and in the corners of an imaginary square the four second reception openings 11b for the longitudinal beams 5a and 5b are disposed. Opposite the first base plate 4a, the second base plate 4b is extended on one side with a somewhat narrower extended region 4g, whereby the rectangular shape is produced. The extended region 4g serves for flange mounting of the electric motor 2a and reception of one of the second suspension bore 16b. Between the reception openings 11b in the region of three of the four edges the three second apertures 10b are disposed, which have the same contour as the opposing first apertures 10a. None of the second apertures 10b are disposed in the area of the extended region 4g.

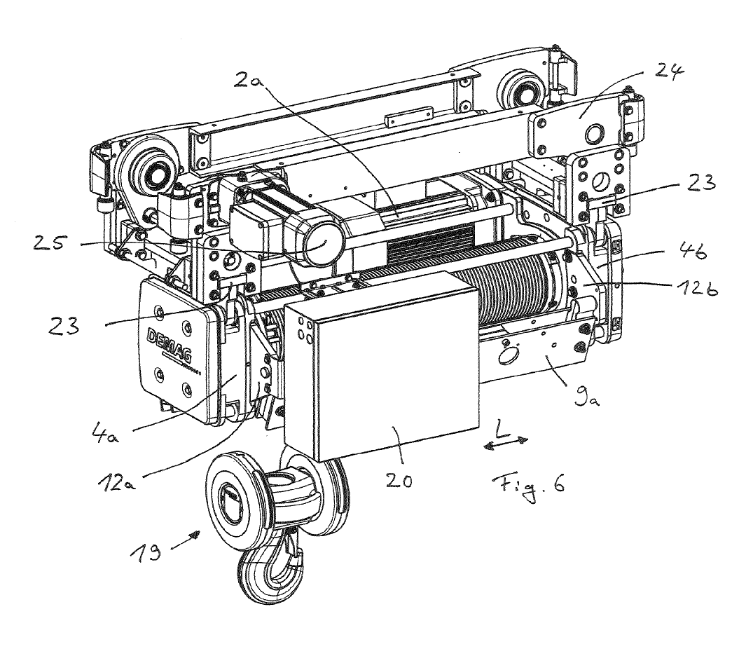

FIG. 6 shows a perspective view of the cable winch 1 in accordance with the invention in an embodiment as a monorail crane trolley in a lower-flange design. Compared with the embodiment as a foot-mounted hoist known from FIG. 1, the mounting elements are not angle elements 8 but holding rails 23 for attaching the cable winch 1 to a travelling mechanism 24 which can travel on a lower flange and has a travel drive 25.

### LIST OF REFERENCE NUMERALS

1 Cable winch

2 Cable drum

2a Electric motor

2b Transmission

3 Base frame

4a First base plate

4b Second base plate

4c Inner side of the first base plate 4a

4d Inner side of the second base plate 4b

4e Outer side of the first base plate 4a

4f Outer side of the second base plate 4b

4g Extended region

5a First longitudinal beam

5b Second longitudinal beam

6a First cover

6b Second cover

7 Holding element

8 Angle elements

9a First mounting cross-beam

9b Second mounting cross-beam

9c Bolt

10a First apertures

10b Second apertures

11a First reception openings

11b Second reception openings

12a First reception plate

12b Second reception plate

12c Attachment region

12d Suspension region

13 Screws

14 Bores

15 Threaded bores

16a First suspension bore

16b Second suspension bore

17 Opening

18a Cable pulley

18b Cable fixed point

19 Lower pulley

19c Deflection rollers

19b Hook

20 Electrical equipment housing

21 Reception arm

22 Holder

23 Holding rails

24 Travelling mechanism

25 Travel drive

D Rotational axis

L Longitudinal axis

1. Cable winch having a base frame comprising at least two base plates, having at least two longitudinal beams connecting the base plates together and being at a spaced disposition with respect to each other, and at least one mounting cross-beam for cable reeving parts, attached to the base plates and extending essentially in parallel with the longitudinal beams, wherein the cable reeving parts are formed as cable pulleys or cable fixed points which are attached to the mounting cross-beam, wherein a plurality of attachment locations are disposed on each of the base plates, on which attachment locations the mounting cross-beam for cable reeving parts can be releasably attached as desired.

2. Cable winch as claimed in claim 1, wherein the base plates are formed in a substantially square or rectangular manner and the attachment locations are disposed on at least two different edges of the base plates.

3. Cable winch as claimed in claim 1, wherein three attachment locations are disposed per base plate.

4. Cable winch as claimed in claim 1, wherein a cable drum is mounted between the base plates and the attachment locations are disposed outside the regions of the base plates concealed by the cable drum when seen in the direction of the rotational axis of the cable drum.

5. Cable winch as claimed in claim 1, wherein the attachment locations are disposed on the inner sides of the base plates.

6. Cable winch as claimed in claim 1, wherein the attachment locations are formed as first apertures on the first base plate and second apertures on the second base plate.

7. Cable winch as claimed in of claim 1, wherein the mounting cross-beam for cable reeving parts can be releasably attached to the base plates via first and second reception plates.

8. Cable winch as claimed in claim 7, wherein the first and second reception plates can be placed into the first and second apertures and have an attachment part projecting beyond the contour of the first and second base plates.

9. Cable winch as claimed in claim 8, wherein the mounting cross-beam is suspended in an oscillating manner on the respective attachment part of the first and second reception plates.

10. Cable winch as claimed in claim 2, wherein three attachment locations are disposed per base plate.

11. Cable winch as claimed in claim 2, wherein a cable drum is mounted between the base plates and the attachment locations are disposed outside the regions of the base plates concealed by the cable drum when seen in the direction of the rotational axis of the cable drum.

12. Cable winch as claimed in claim 3, wherein a cable drum is mounted between the base plates and the attachment locations are disposed outside the regions of the base plates concealed by the cable drum when seen in the direction of the rotational axis of the cable drum.

13. Cable winch as claimed in claim 10, wherein a cable drum is mounted between the base plates and the attachment locations are disposed outside the regions of the base plates concealed by the cable drum when seen in the direction of the rotational axis of the cable drum.

14. Cable winch as claimed in claim 2, wherein the attachment locations are disposed on the inner sides of the base plates.

15. Cable winch as claimed in claim 3, wherein the attachment locations are disposed on the inner sides of the base plates.

16. Cable winch as claimed in claim 4, wherein the attachment locations are disposed on the inner sides of the base plates.

17. Cable winch as claimed in claim 13, wherein the attachment locations are disposed on the inner sides of the base plates.

18. Cable winch as claimed in claim 17, wherein the attachment locations are formed as first apertures on the first base plate and second apertures on the second base plate.

19. Cable winch as claimed in claim 18, wherein the mounting cross-beam for cable reeving parts can be releasably attached to the base plates via first and second reception plates.

20. Cable winch as claimed in claim 19, wherein the first and second reception plates can be placed into the first and second apertures and have an attachment part projecting beyond the contour of the first and second base plates.

21. Cable winch as claimed in claim 20, wherein the mounting cross-beam is suspended in an oscillating manner on the respective attachment part of the first and second reception plates.
